(19) United States
(12) Patent Application Publication
(10) Pub. No.: US 2019/0226693 A1
(43) Pub. Date: Jul. 25, 2019

(54) INSERT ELEMENT FOR INSERTING INTO A DEVICE FOR HUMIDIFYING, CLEANING AND/OR COOLING A FLUID, IN PARTICULAR A GAS, SUCH AS, FOR EXAMPLE, AIR

(71) Applicant: Hewitech GmbH & Co. KG, Ochtrup (DE)

(72) Inventor: Frank DIRKSKÖTTER, Ochtrup (DE)

(73) Assignee: Hewitech GmbH & Co. KG, Ochtrup (DE)

(21) Appl. No.: 16/087,166

(22) PCT Filed: Mar. 20, 2017
(86) PCT No.: PCT/EP2017/056577

§ 371 Date: Oct. 31, 2018

(30) Foreign Application Priority Data
Mar. 23, 2016 (DE) 20 2016 101 597.9

(51) Int. Cl. F24F 3/14; F28F 25/08; F24F 6/04; F24F 3/16; B01D 45/10

(52) U.S. Cl. CPC F24F 3/14; F28F 25/087; F24F 6/04; F24F 2003/1617; B01D 45/10; F24F 2006/046; F24F 3/1603

(57) ABSTRACT

The invention relates to an insert element for inserting into a device for humidifying, cleaning and/or cooling a fluid, in particular a gas, such as, for example, air, said insert element comprising an insert body (10) which can be wetted with a liquid, in particular water, and through which a gas, in particular air, can flow and which has a flow inlet side and a flow outlet side and, between said sides, is provided with regions which can be wetted by the liquid and can be exposed to the fluid. The insert body (10) has a multi-layered design and has a number of undulated grid-type plate elements (12) which bear against one another, are limited by an edge (14, 16) and are provided with elevations and depressions. A film-type plate element (19, 19′) is mounted between at least two adjacent grid plate elements (12). The film-type plate element (19, 19′) is perforated.

The invention relates to an insert element for inserting into a device for humidifying, cleaning and/or cooling a fluid, in particular a gas such as, for example, air.

Devices of this type are also known as evaporation humidifiers and material exchangers (see e.g. WO 2009/153278 A1) which are used, inter alia, for humidifying and cooling the air e.g. in residential and office buildings, warehouses, stables, greenhouses and other rooms and technical installations, e.g. for the cleaning and particularly dedusting of inlet and outlet air, and for reactive cleaning of gas or air (particularly removal of odorants such as e.g. ammonia from the outlet air of stables). Cooling of a gas with the aid of such devices is performed according to the principle of adiabatic cooling (evaporative cooling).

Known devices of the above mentioned types comprise insert elements which include a plurality of plate elements or material layers that in most cases are undulated so that, with adjacent plate elements arranged in tight abutment with each other, mutually intersecting channels are generated through which the gas will flow in via an inlet side of the device, flow through the device and flow out of the device again on an opposite outlet side. The inlet and outlet sides of the device are formed by mutually opposite edges of the individual adjacent plate elements. Thus, the gas will flow parallel to the extension of the plate elements between their respective edges and between the plate elements.

The insert elements of the above mentioned type are wetted with liquid, particularly water, so that the gas to be treated will flow along wetted surfaces of the plate elements. In this regard, it is desirable that the wetting liquid form a surface area as large as possible and will remain within the device and respectively on the plate elements over a longer period of time.

Known devices of the above mentioned types comprise closed material layers and respectively plate elements made of plastic or paper which are welded or bonded to each other. Plate elements of paper have the disadvantage that the bodies assembled of them that allow the gas to flow through them cannot be cleaned without a risk of destroying the paper plate elements. In this regard, plate elements made of plastic are to be preferred. Both known systems, however, have the further disadvantage of not yet allowing for an optimal exchange of gas with the liquid, which may have an adverse effect on the efficiency of the gas treatment. Further, these devices present a relatively high flow resistance, which, too, is undesirable.

Examples of the above mentioned devices are described in U.S. Pat. Nos. 3,262,682, 3,415,502, 6,544,628, DE-A-26 32 020, DE-A-16 79 515, WO-A-2006/103028 and DE-U-20 2006 018 753.

Devices of the above mentioned type, however, are not only used for the cooling of gas but also for the cooling of liquids such as e.g. water. An example of such a use is an insert element for a cooling tower of a power plant, wherein the plate element bodies installed in the cooling tower will be sprayed with the to-be-cooled liquid which then will be cooled by an air flow generated by the stack.

As of yet, the insert bodies of the known devices consist of mutually superimposed plates from which parallelepipedic bodies are produced as plate bodies.

These blocks are then arranged next to each other and respectively stacked above each other. In larger plants, this may cause instabilities of the structure assembled of the plate element bodies standing above each other.

It is an object of the invention to provide an insert element for inserting into a device for humidifying, cleaning and/or cooling a fluid, in particular a gas such as, for example, air, wherein the plate element body is designed to be self-stabilizing and to operate with high efficiency even in case of large dimensions.

To achieve the above object, the invention provides an insert element for inserting into a device for humidifying, cleaning and/or cooling a fluid, in particular a gas, such as e.g. air, said insert element comprising
an insert body adapted to be wetted with a liquid, in particular water, the outer side of the insert body comprising a flow inlet side and a flow outlet side and, between these sides, being provided with regions adapted to be wetted with the liquid and to be exposed to a gas, in particular air, wherein the insert body and its regions between the flow inlet side and the flow outlet side are configured to allow the gas to flow therethrough,
wherein the insert body has a multi-layered design and has a plurality of mutually abutting undulated grid-type plate elements which are each delimited by an edge and are provided with elevations and depressions,
wherein, between at least two adjacent grid plate elements, at least one film-type plate element is arranged and
wherein the film-type plate element is perforated.

Individual embodiments of the invention are the subject matter of the dependent claims.

According to the invention, the insert body consists, per layer, of a plurality of grid-type plate elements abutting each other by their edges, wherein the grid-type plate elements of adjacent layers cover the opposite edges of the plates of the adjacent layer. In this manner, there is generated an assembly of grid-type plate elements, notably not only just in one dimension (e.g. width dimension of the layers) but optionally also in two dimensions (namely width and length dimension of the layers).

According to the invention, the insert body comprises, besides the grid-type plate elements, also film-type plate elements which are perforated. These film-type plate elements are arranged between some of the adjacent layers of grid-type plate elements and optionally extend across grid-type plate elements which optionally are arranged next to each other per layer. Apart from increasing the dwelling time of the liquid in the insert body, they serve also for stabilization of the insert body. The perforations have the effect that the water, when running down, will form films wetting the perforations, wherein the films have a large surface because the water films are exposed on both sides. Alternatively, the film-type plate elements can also be undulated or zig-zag-shaped, i.e. they can be structured.

It is not required that the film-type plate elements are arranged alternately with the layers of grid-type plate elements. This, however, may be provided that way. As such, it will be sufficient to arrange the perforated film-type plate elements according to the invention only between individual adjacent layers of grid-type plate elements.

The grid-type plate elements of the insert element of the invention are preferably arranged at a mutual offset with respect to two adjacent layers, thus generating a stable composite structure. This composite structure is additionally reinforced in that the grid-type plate elements of adjacent layers are fixed to each other by plug or locking connections or by pin/hole or rivet connections with cold or hot deformation of the material generating the cohesion, so as to counteract shear forces.

According to an advantageous embodiment of the invention, it is provided that the grid-type plate elements each comprise longitudinal and transverse edge portions and that adjacent grid-type plate elements of a layer are arranged to face each other respectively by their longitudinal edges and/or by their transverse edges. Herein, it is suitably further provided that the insert body comprises tie bars running in the direction of the succession the layers and extending through mutually abutting grid-type plate elements of the layers. Thereby, a compact unit is generated, wherein, per insert body, there can be provided a plurality of tie bars distributed over the insert body.

The insert bodies produced by the mutually displaced plates suitably have a parallelepipedic shape. Thus, their lateral surfaces are formed by the outer edges of the grid-type plate elements while the top and bottom sides of the insert bodies are formed by the grid-type plate elements of the two outer layers.

In this arrangement, the outer edges of the grid-type plate elements of the individual layers can aligned with each other, i.e. they can be arranged, on each outer side of the insert body, in a respective common plane, or, however, they can be arranged at an offset from each other and thus have a shape that is adapted to the respective installation situation of the insert body. Thus, for instance, it is possible that the body has a stair-like shape.

When such an insert body is used for the cooling of gas according to the principle of adiabatic cooling, the flow inlet and flow outlet sides of the insert body and respectively cooling body are formed by two mutually opposite lateral faces of the cooling body. The liquid will be applied (particularly sprayed) onto the top side of the cooling body and will flow through the latter transversely to the gas flow and with resulting wetting of the perforated grid-type plate elements (gas cooling according to the cross-flow principle). When the cooling body is used in a cooling tower, the cooling of the water will function according to the counterflow principle in that the to-be-cooled liquid is again applied onto the cooling body from above and the gas will flow from the bottom side to the top side of the cooling body through the latter.

It is particularly suitable if the grid-type plate elements are perforated. In this connection, it appears useful to provide the grid-type plate elements in the form of grid-type mats. In this embodiment of the invention, the insert body which can be wetted by a liquid, particularly water, while adapted to allow the to-be-treated gas to flow through it, is composed of a plurality of undulated grid-type plate elements made of plastic and provided with perforations. Due to these perforations, a gas exchange can occur between adjacent grid-type plate elements through these elements. This will improve the material exchange rate between gas and liquid and reduce the flow resistance. Thus, the body proposed by the invention is configured to allow a flow through it in three dimensions.

The perforated grid-type plate elements will result in local turbulences of the gas flowing through the insert body, thus improving the exchange of the gas with the liquid.

The insert body according to the invention is of particular use for the adiabatic cooling of air to be supplied to stables or greenhouses since the perforated grid-type plate elements make it possible, while forming an enlarged surface area, to hold a larger quantity of liquid in the body and to hold the liquid there for a longer period of time. The grid-type plate elements, which according to the invention serve inter alia for stabilization, are perforated and optionally structured. They increase the dwelling time of the liquid in the insert body for gas treatment and thus are of advantage in two regards.

As already mentioned above, it is particularly suitable if the grid-type plate elements are designed as grid-type mats which comprise grid bars with perforations provided between them in the form of free spaces between adjacent grid bars. On the grid bars, the wetting liquid will be held while forming a quite large surface area, resulting in an enlarged contact area of the gas with the liquid.

By way of alternative to the grid-type plate elements, there can be provided film elements in which perforations are formed e.g. by punching.

The undulated grid-type plate elements comprise mutually adjacent elevations and depressions that are configured e.g. in the form of valleys and mountains.

In such a configuration, the lateral flanks between a depression and an elevation suitably comprise the projections. The elevations and depressions suitably extend at an inclination relative to the opposite edges of the grid-type plate elements forming the inlet and outlet sides of the wettable insert body. Alternatively, they can also extend in a zig-zag shape between these edges or in another manner deviating from a linear extension.

Suitable plastic materials for the grid-type plate elements are polyolefins and particularly thermoplastics such as e.g. PP or PE. Instead of using plastic material, however, the grid-type plate elements can also be made of paper or cardboard.

As already mentioned above, the insert body of the invention preferably can be produced, as it were, in an “endless” manner in that a plurality of grid-type plate elements, while arranged above and next to each other and at a mutual offset, are assembled to a stack of grid-type plate elements likewise arranged next to each other and at a mutual offset. Generated in this manner is a stack of grid-type plate elements whose height can be preset and which can be extended in its width and respectively depth by lateral “annexes” so that, by cutting this stack of grid-type plate elements that is growing in width and depth, individual blocks of grid-type plate elements of desired lengths can be obtained. The above described “endless” production can be realized manually or by machine and is described in detail in the already mentioned publication WO 2009/153278 A1.

According to an advantageous embodiment of the invention, it is provided that, between two adjacent, mutually superimposed grid-type plate elements, in the lower region of the stack of grid-type plate elements facing toward the support surface as well as in the upper region of the stack of grid-type plate elements facing away from the support surface, additionally stiffening film strips are inserted; also these can be perforated, if required.

Suitably, the stiffening film strips will be inserted, during assembly of the stack of grid-type plate elements, between the two grid-type plate elements of respectively two pairs of grid-type plate elements arranged at an offset above each other.

According to a first variant of the invention, it is each time individual grid-type plate elements that are arranged above each other and at an offset next to each other. Alternatively, each time, a plurality of grid-type plate elements will be arranged in alignment above each other to form groups of grid-type plate elements, and the thus generated groups of grid-type plate elements will be arranged above each other and next to each other at a mutual offset to form the stack of grid-type plate elements.

For said endless production, it has been found to be of particular advantage to arrange the grid-type plate elements at a mutual offset in a manner forming a step-like offset configuration of the stack of grid-type plate elements. By way of alternative thereto, the grid-type plate elements or groups of grid-type plate elements can be arranged with an alternating offset so that, when viewed in height direction of the stack of grid-type plate elements, each second grid-type plate element or each second group of grid-type plate elements is arranged in alignment to another plate element or group of plate elements.

The invention will be explained in greater detail hereunder by way of exemplary embodiments and with reference to the drawing. In the drawing, the following is shown:

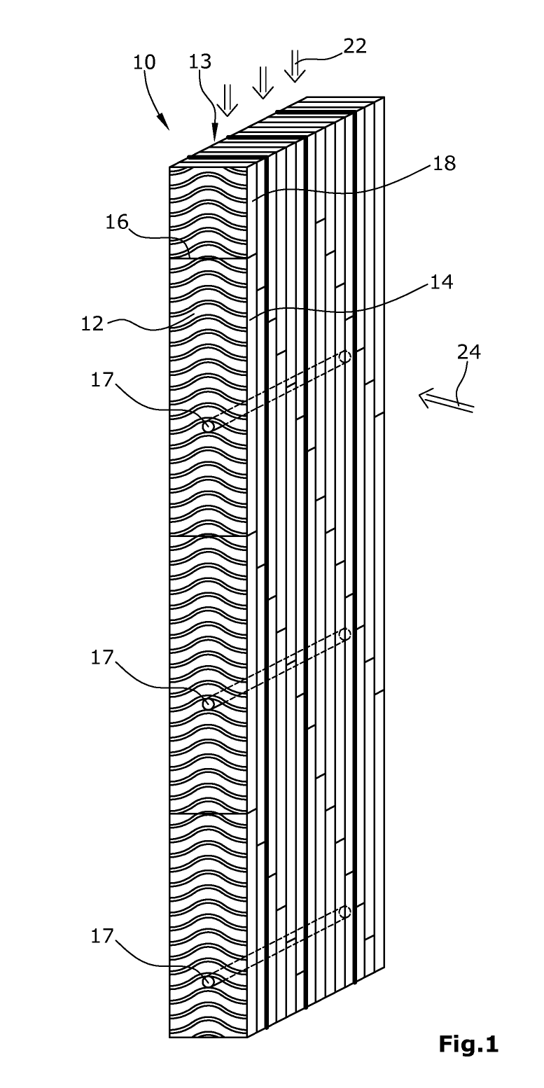

FIG. 1 shows a perspective view of an insert body composed of a plurality of layers which are arranged next to each other and each comprise a plurality of mutually superimposed grid-type plate elements,

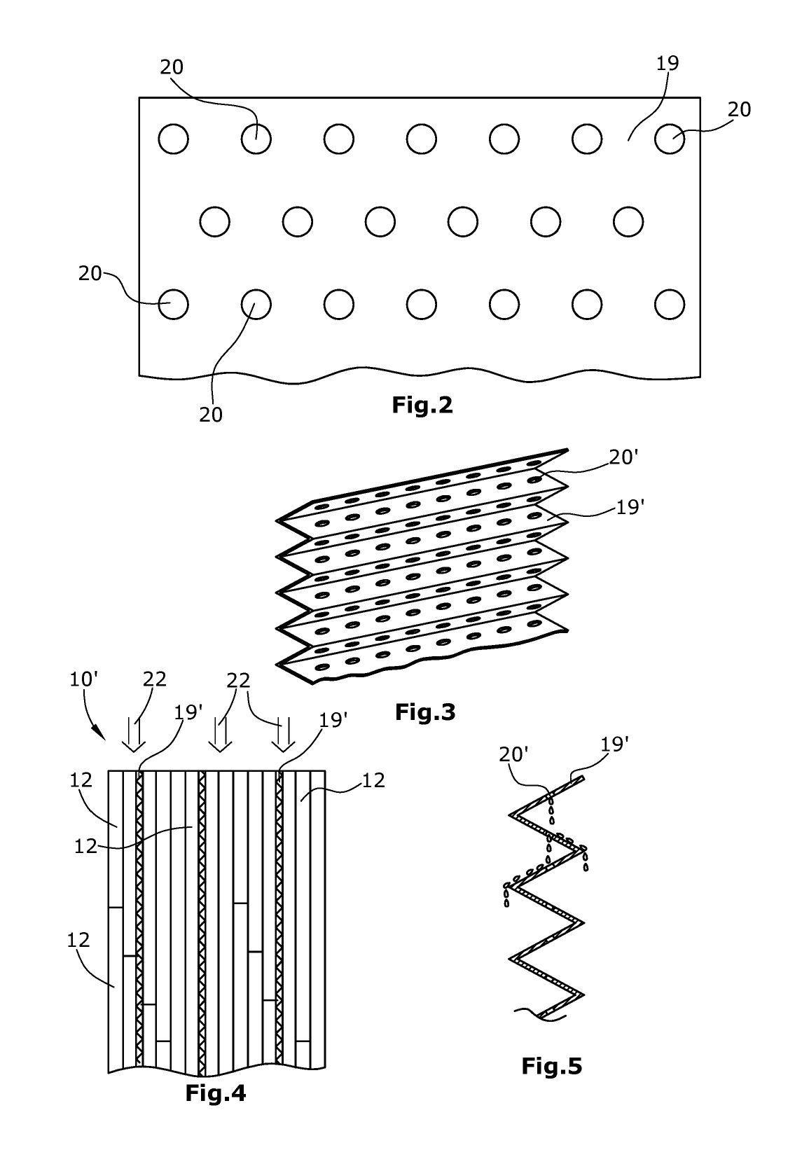

FIG. 2 shows a plan view onto a partial section of a perforated film-type plate element which is formed as a plane element,

FIG. 3 shows an alternative to the film-type plate elements according to claim 2 in which the film-type plate element is folded, i.e. is zig-zag-shaped or undulated,

FIG. 4 shows a lateral view of the insert body configured according to FIG. 1, however with zig-zag-shaped film-type plate elements, and

FIG. 5 shows a schematic view of the course of the water drops moving along the zig-zag-structured film-type plate element.

FIG. 1 shows an insert body 10 which in the present exemplary embodiment is used as a cooling body and which is composed of individual undulated plastic grid-type plate elements 12 that are arranged next to each other and above each other as well as in upright positions. Insert body 10 herein comprises a plurality of layers 13 of such grid-type plate elements 12, wherein the grid-type plate elements 12 are arranged, per layer 13, above each other (with respect to the orientation of insert body 10 according to FIG. 1). Each grid-type plate element 12 comprises two opposite longitudinal edges 14 and two transverse edges 16 which, because of the undulated structures of the plastic grid-type plate element 12, also extend in a undulated configuration. When, now, two such grid-type plate elements 12 in mutually adjacent layers 13 of insert body 10 will be laid against each other so that their undulations will intersect, there will be generated openings 18 (not shown in detail in the Figure) which are followed by channels passing through insert body 10, as is known per se. Between some adjacent layers 13 of grid-type plate elements 12, pairs of film-type plate elements 19 are arranged which are perforated. The perforations 20 are shown in FIG. 2.

FIG. 3 shows an alternative embodiment of the film-type plate elements 19′ wherein these are folded and zig-zag-shaped, respectively. The folding can be formed transversely to the longitudinal extension or also at an angle other than 90° to the longitudinal extension of the film-type plate element 19′. The perforations 20′ are arranged in the flank regions.

FIG. 4 shows a lateral view of an insert body provided as a cooling body 10′ and comprising structured, perforated grid-type plate element 12.

FIG. 5 shows a schematic view illustrating the manner in which the zig-zag-shaped film-type plate elements 19′ serve for distribution of water. In this regard, it is to be noted that the liquid is supplied in the direction of the arrows 22 in FIGS. 1 and 4 onto the top side of the standing cooling body 10 and respectively 10′ while the to-be-treated gas flows through the cooling body 10 and respectively 10′ in the direction of arrow 24.

### LIST OF REFERENCE NUMERALS

10 insert body, cooling body
10′ cooling body
11 top side
12 plastic grid-type plate elements, grid-type plate element
13 layer, outer layers
14 longitudinal edges
15 bottom side
16 transverse edges
17 tie bars
18 openings
19 film-type plate element, grid-type plate elements
19′ film-type plate elements
20 perforations
20′ perforations
22 arrows
24 arrows
32 elevations
34 depressions

1. An insert element for inserting into a device for humidifying, cleaning and/or cooling a fluid, in particular a gas, such as e.g. air, said insert element comprising
an insert body adapted to be wetted with a liquid, in particular water, the outer side of the insert body comprising a flow inlet side and a flow outlet side and, between these sides, being provided with regions adapted to be wetted with the liquid and to be exposed to a gas, in particular air, wherein the insert body and its regions between the flow inlet side and the flow outlet side are configured to allow the gas to flow therethrough,
wherein the insert body has a multi-layered design and has a plurality of mutually abutting undulated grid-type plate elements which are each delimited by an edge and are provided with elevations and depressions,
wherein, between at least two adjacent grid plate elements, at least one film-type plate element is arranged and
wherein the film-type plate element is perforated.

2. The insert element according to claim 1, wherein the at least one film-type plate element is of plane or structured shape, particularly an undulated or zig-zag shape.

3. The insert element according to claim 1, wherein, between a plurality of pairs of mutually adjacent grid-type plate elements, a respective film-type plate element is arranged.

4. The insert element according to claim 1, wherein the insert body comprises, per layer, a plurality of grid-type plate elements abutting each other by their mutually confronting edges, and that at least one film-type plate element is arranged between the grid-type plate elements of at least one pair of adjacent layers and covers the grid-type plate elements of these layers.

5. The insert element according to claim 4, wherein the mutually confronting edges of respectively two adjacent grid-type plate elements of a layer are covered by a grid-type plate element of the adjacent layer of the insert body.

6. The insert element according to claim 1, wherein the grid-type plate elements each comprise longitudinal and transverse edges and that adjacent grid-type plate elements of a layer are arranged to face each other respectively by their longitudinal edges and/or by their transverse edges.

7. The insert element according to claim 1, wherein the insert body comprises tie bars running in the direction of the succession of the layers of grid-type plate elements and extending through mutually abutting grid-type plate elements and the at least one film-type plate elements.

8. The insert element according to claim 1, wherein the outer side of the insert body comprises continuous lateral faces formed by the edges of the grid-type plate elements, and top and bottom sides formed by the grid-type plate elements of the outer layers.

9. The insert element according to claim 8, wherein the flow inlet and outlet sides are formed by two mutually opposite outer side faces of the insert body and thus define the direction of the gas flow passing through the insert body, and that the insert body can be sprayed with liquid from its top side, the liquid passing through the insert body transversely to the gas flow while wetting the grid-type plate elements.

10. The insert element according to claim 9, wherein the flow inlet side is formed by the bottom side of the insert body and the flow outlet side is formed by the top side of the insert body and that the insert body can be sprayed with liquid from its top side, the liquid passing through the insert body oppositely to the gas flow while wetting the grid-type plate elements.

11. The insert element according to claim 1, wherein the elevations and depressions extend at an inclination relative to the mutually opposite edges of the grid-type plate elements and/or between the latter in an undulated or zig-zag shape or in another manner deviating from a linear extension.

12. The insert element according to claim 1, wherein adjacent grid-type plate elements are connected to each other by plug or locking connections or by pin/hole or rivet connections with cold or hot deformation of the material generating the cohesion of the material generating the connection.

13. The insert element according to claim 1, the grid-type plate elements and the at least one film-type plate element are made of plastic, paper or cardboard.
